(19) United States
(12) Patent Application Publication
(10) Pub. No.: US 2023/0322540 A1
(43) Pub. Date: Oct. 12, 2023

(54) Cocktail Dispensing Assembly

(71) Applicant: Danielle Johnson, Mesa, AZ (US)

(72) Inventor: Danielle Johnson, Mesa, AZ (US)

(21) Appl. No.: 17/714,613

(22) Filed: Apr. 6, 2022

(51) Int. Cl. B67D 1/00; B67D 1/08; G07F 13/06; G07F 9/00; G07F 7/02

(52) U.S. Cl. CPC B67D 1/0041; B67D 1/0034; B67D 1/0878; G07F 13/065; G07F 9/009; G07F 7/025

(57) ABSTRACT

A cocktail dispensing assembly includes a housing that is positionable in an establishment licensed to sell alcohol and a dispensing outlet is integrated into the housing. An alcohol dispensing unit is integrated into the housing to dispense a pre-determined volume of a distilled spirit outwardly through the dispensing outlet. A mixer dispensing unit is integrated into the housing to dispense a pre-determined volume of a cocktail mixer outwardly through the dispensing outlet. In this way the distilled spirit and the mixer can be dispensed in the beverage container. A point of sale unit is integrated into the housing to conduct a financial transaction to purchase a cocktail. An identification reader is integrated into the housing to read a state issued identification card. A facial recognition unit is integrated into the housing to scan a face of a user for to inhibiting an unauthorized user from purchasing alcohol.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to dispensing devices and more particularly pertains to a new dispensing device for dispensing a variety of cocktails. The device includes an alcohol dispensing unit which contains a variety of distilled spirits and a mixer dispensing unit for dispensing a variety of mixers. The device includes a point of sale unit for paying for a cocktail and an identification reader for reading a state issued identification card. The device dispenses a cocktail containing a chosen distilled spirit and a chosen mixer when payment has been received and the identification has been verified. The device includes a facial recognition unit for verifying the face of the user matches the information on the state issued identification card.

### (2) Description of Related Art Including Information Disclosed Under 37 CFR 1.97 and 1.98

The prior art relates to dispensing devices including an automated alcohol dispenser that is in communication with a cash register in a tavern or restaurant. The prior art discloses a variety of automated cocktail dispensing devices for automatically mixing a cocktail. The prior art discloses a vending machine that includes payment processing, an identification reader for reading a state issued identification card and a facial recognition unit for verifying a user's face against the state issued identification card for vending regulated materials. In no instance does the prior art disclose a cocktail vending unit that includes facial recognition, a plurality of alcohol reservoirs and a plurality of mixer reservoirs for dispensing a custom ordered cocktail.

### BRIEF SUMMARY OF THE INVENTION

An embodiment of the disclosure meets the needs presented above by generally comprising a housing that is positionable in an establishment licensed to sell alcohol and a dispensing outlet is integrated into the housing. An alcohol dispensing unit is integrated into the housing to dispense a pre-determined volume of a distilled spirit outwardly through the dispensing outlet. A mixer dispensing unit is integrated into the housing to dispense a pre-determined volume of a cocktail mixer outwardly through the dispensing outlet. In this way the distilled spirit and the mixer can be dispensed in the beverage container. A point of sale unit is integrated into the housing to conduct a financial transaction to purchase a cocktail. An identification reader is integrated into the housing to read a state issued identification card. A facial recognition unit is integrated into the housing to scan a face of a user for to inhibiting an unauthorized user from purchasing alcohol.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a cocktail dispensing assembly according to an embodiment of the disclosure.

FIG. 2 is a left side phantom view of an embodiment of the disclosure.

FIG. 3 is a back phantom view of an embodiment of the disclosure.

FIG. 4 is a front view of an embodiment of the disclosure.

FIG. 5 is a schematic view of an embodiment of the disclosure.

### DETAILED DESCRIPTION OF THE INVENTION

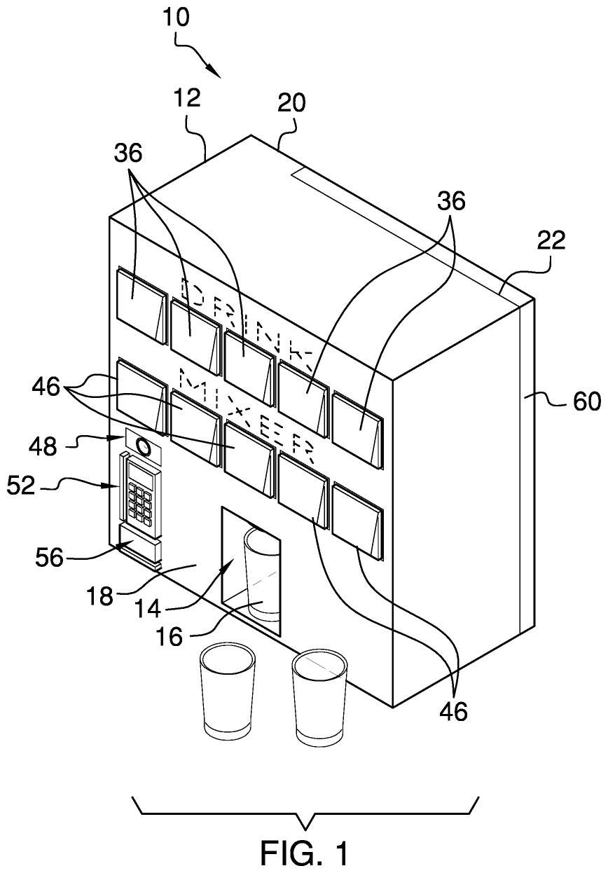

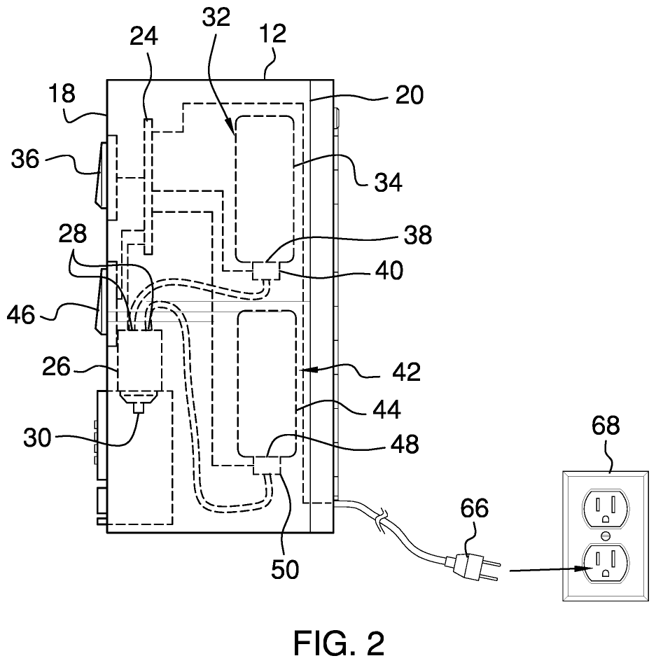

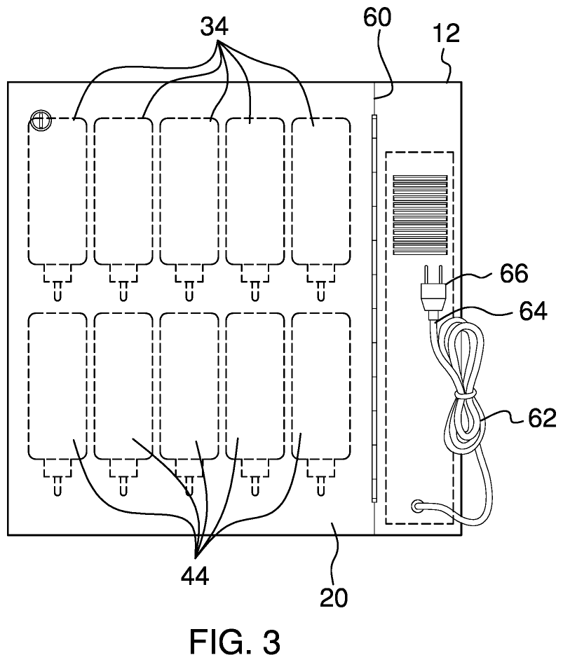

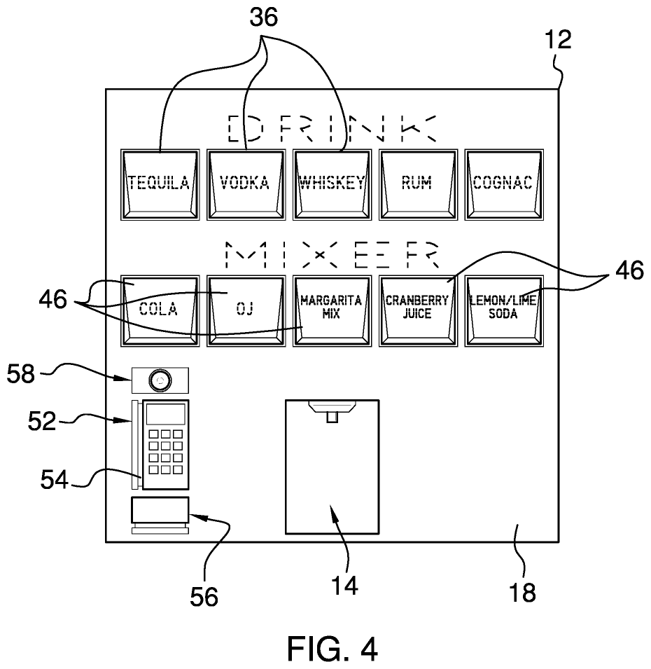

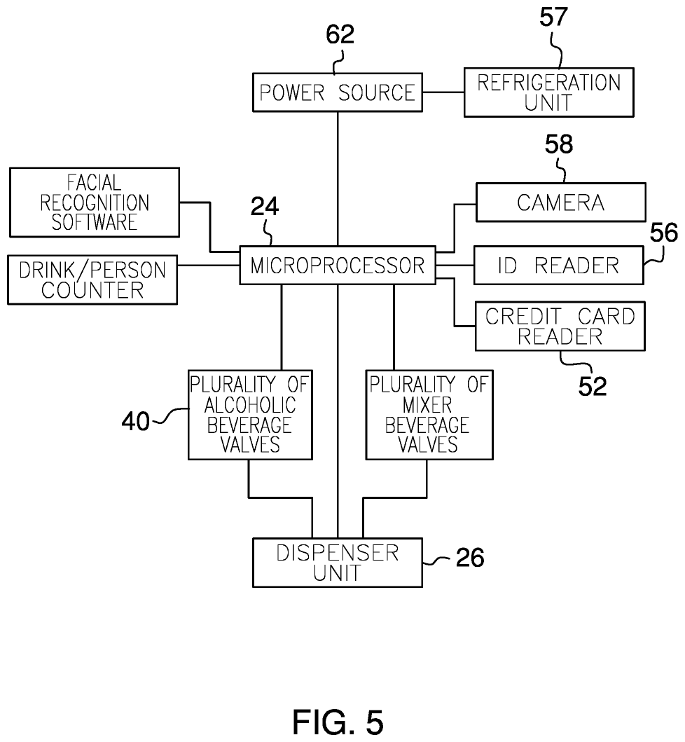

With reference now to the drawings, and in particular to FIGS. 1 through 5 thereof, a new dispensing device embodying the principles and concepts of an embodiment of the disclosure and generally designated by the reference numeral 10 will be described.

As best illustrated in FIGS. 1 through 5, the cocktail dispensing assembly 10 generally comprises a housing 12 that is positionable in an establishment licensed to sell alcohol. In this way the housing 12 is accessible to customers that are legally allowed to purchase alcohol. The establishment may be a tavern, a lounge, a restaurant or any other public business that has on sale liquor licensing. A dispensing outlet 14 is integrated into the housing 12 to receive a beverage container 16, such as a high ball glass, a tumbler or other similar type of beverage container 16 that would commonly be found in a bar setting. The housing 12 has a front wall 18 and a back wall 20, and the back wall 20 has an opening 22 extending through the back wall 20 to access an interior of the housing 12. Furthermore, the dispensing outlet 14 extends through the front wall 18 to facilitate the beverage container 16 to be placed into the dispensing outlet 14.

A control circuit 24 is integrated into the housing 12 and the control circuit 24 receives a payment input and a verify input. The control circuit 24 is normally de-actuated and the control circuit 24 is actuated when the control circuit 24 receives the payment input and the verify input. A dispensing valve 26 is integrated into the housing 12 and the dispensing valve 26 has a pair of inlets 28 and an outlet 30. The outlet 30 is aligned with the dispensing outlet 14 and the dispensing valve 26 is electrically coupled to the control circuit 24. Furthermore, the dispensing valve 26 may having a fluid capacity of at least 12.0 ounces thereby facilitating the dispensing valve 26 to contain a volume of fluid that would commonly be served as a cocktail.

An alcohol dispensing unit 32 is provided and the alcohol dispensing unit 32 is integrated into the housing 12. The alcohol dispensing unit 32 has a plurality of alcohol reservoirs 34 each containing a respective distilled spirit, including but not being limited to, rum, whiskey, tequila, gin and vodka. The alcohol dispensing unit 32 includes a plurality of alcohol buttons 36 that is each disposed on the housing 12. Each of the alcohol buttons 36 is in operational communication with a respective one of the alcohol reservoirs 34. Moreover, each of the alcohol buttons 36 actuates the respective alcohol reservoir 34 to dispense a pre-determined volume of the distilled spirit outwardly through the dispensing outlet 14. In this way the alcohol dispensing unit 32 can dispense the distilled spirit into the beverage container 16.

Each of the alcohol buttons 36 is positioned on the front wall 18 and the alcohol buttons 36 is spaced apart from each other and is laterally distributed on the front wall 18. Additionally, each of the alcohol buttons 36 is electrically coupled to the control circuit 24. Each of the alcohol reservoirs 34 has an outlet port 38 and each of the alcohol reservoirs 34 includes an alcohol valve 40 that is fluidly coupled to the outlet port 38. The alcohol valve 40 associated with each of the alcohol reservoirs 34 is electrically coupled to the control circuit 24 and the alcohol valve 40 associated with each of the alcohol reservoirs 34 is assigned to a respective one of the alcohol buttons 36. Additionally, the alcohol valve 40 may comprise an electronically controlled liquid valve or the like that releases a pre-determined volume of fluid each time it is actuated. Each of the alcohol buttons 36 may be labeled with the distilled spirit that is contained in the respective alcohol reservoir 34.

The alcohol valve 40 associated with a respective one of the alcohol reservoirs 34 is actuated into an open condition when the respective alcohol button 36 is depressed. In this way the distilled spirit in the respective alcohol reservoir 34 can flow through the alcohol valve 40. The alcohol valve 40 associated with each of the alcohol reservoirs 34 is fluidly coupled to a respective one of the inlets 28 of the dispensing valve 26 and the alcohol valve 40 associated with each of the alcohol reservoirs 34 is normally actuated into a closed condition. Conversely, the alcohol valve 40 associated with each of the alcohol reservoirs 34 is actuated into the open condition when the control circuit 24 receives the payment input and the verify input.

A mixer dispensing unit 42 is provided and the mixer dispenser unit 42 is integrated into the housing 12. The mixer dispensing unit 42 has a plurality of mixer reservoirs 44 each containing a respective cocktail mixer, including but not being limited to, cola, club soda, lime juice, triple sec, orange juice, water and other mixers commonly mixed in a cocktail. The mixer dispensing unit 42 includes a plurality of mixer buttons 46 that is each disposed on the housing 12. Each of the mixer buttons 46 is in operational communication with a respective one of the mixer reservoirs 44 such each of the mixer buttons 46 actuates the respective mixer reservoir 44 to dispense a pre-determined volume of the cocktail mixer outwardly through the dispensing outlet 14. In this way the mixer dispensing unit 42 can dispense the cocktail mixer into the beverage container 16.

Each of the mixer buttons 46 is positioned on the front wall 18 of the housing 12. The mixer buttons 46 are spaced apart from each other and are laterally distributed on the front wall 18. Each of the mixer buttons 46 is positioned beneath a respective one of the alcohol buttons 36 and each of the mixer buttons 46 is electrically coupled to the control circuit 24. Each of the mixer reservoirs 44 has an outlet port 48 and each of the mixer reservoirs 44 includes a mixer valve 50 that is fluidly coupled to the outlet port 48 of the mixer reservoirs 44. The mixer valve 50 associated with each of the mixer reservoirs 44 is electrically coupled to the control circuit 24. Additionally, the mixer valve 50 associated with each of the mixer reservoirs 44 is assigned to a respective one of the mixer buttons 46. The mixer valve 50 may comprise an electronically controlled liquid valve or the like that releases a pre-determined volume of fluid each time it is actuated.

The mixer valve 50 associated with a respective one of the mixer reservoirs 44 is actuated into an open condition when the respective mixer button 46 is depressed. In this way the cocktail mixer in the respective mixer reservoir 44 can flow through the mixer valve 50. The mixer valve 50 associated with each of the mixer reservoirs 44 is fluidly coupled to a respective one of the inlets 28 of the dispensing valve 26. In this way the dispensing valve 26 can mix the distilled spirit and the cocktail mixer together. The mixer valve 50 associated with each of the mixer reservoirs 44 is normally actuated into a closed condition. Conversely, the mixer valve 50 associated with each of the mixer reservoirs 44 is actuatable into the open condition when the control circuit 24 receives the payment input and the verify input.

A point of sale unit 52 is integrated into the housing 12 for conducting a financial transaction to purchase a cocktail. The point of sale unit 52 is in operational communication with each of the alcohol dispensing unit 32 and the mixer dispensing unit 42. Furthermore, the point of sale unit 52 comprises a card reader 54 that is disposed on the front wall 18 of the housing 12. Additionally, a credit card or debit card can be swiped through the card reader 54 for purchasing the cocktail. The card reader 54 is electrically coupled to the control circuit 24 and the control circuit 24 receives the payment input when the card reader 54 successfully charges the credit card or the debit card for the cost of the cocktail. The card reader 54 may be in communication with an extrinsic communication network to facilitate the card reader 54 to debit charges against the credit card or the debit card.

An identification reader 56 is integrated into the housing 12 for reading a state issued identification card, such as a driver's license, for example. The identification reader 56 is positioned on the front wall 18 of the housing 12 and the identification reader 56 is electrically coupled to the control circuit 24. The identification reader 56 may be an electronic scanner or other similar electronic device that can read a bar code on the state issued identification card in order to obtain identification information, such as date of birth, of a user's state issued identification card. A refrigeration unit 57 may be integrated into the housing 12 for cooling the alcohol reservoirs 34 and the mixer reservoirs 44.

A facial recognition unit 58 is integrated into the housing 12 thereby facilitating the facial recognition unit 58 to scan a face of the user. The facial recognition unit 58 verifies the user's face with the information on the state issued identification card. In this way the facial recognition unit 58 can inhibit an unauthorized user from purchasing alcohol. Furthermore, the facial recognition unit 58 inhibits an unauthorized user from employing a stolen state issued identification card, for example. The facial recognition unit 58 is positioned on the front wall 18 of the housing 12 and the facial recognition unit 58 is electrically coupled to the control circuit 24. Additionally, the control circuit 24 receives the verify input when the facial recognition unit 58 verifies that the user's face matches the information on the state issued identification card. The facial recognition unit 58 may include a digital camera and facial analysis software for analyzing and comparing the user's face to the picture on the state issued identification card.

A door 60 is hingedly disposed on the back wall 20 of the housing 12. The door 60 is aligned with the opening 22 for opening and closing the opening 22. A lock 61 is integrated into the door 60 and the lock 61 engages the back wall 20 of the housing 12 when the door 60 is closed and when the lock 61 is in a locked condition. The lock 61 is urgeable into an unlocked condition with a key for disengaging the back wall 20 of the housing 12 to facilitate the door 60 to be opened. A power cord 62 is coupled to and extends away from the housing 12 and the power cord 62 is electrically coupled to the control circuit 24. The power cord 62 has a distal end 64 with respect to the housing 12 and a male plug 66 is electrically coupled to the distal end 64. The male plug 66 can be plugged into a power source 68 comprising a female electrical outlet 30.

In use, user passes their state issued identification card through the identification reader 56 and the user passes their credit card or debit card through the card reader 54. The facial recognition unit 58 verifies that the user is the individual that is represented on the state issued identification card. The user depresses the alcohol button 36 that corresponds to their desired distilled spirit and the user depressed the mixer button 46 that corresponds to their desired mixer. In this way the chosen distilled spirit and the chosen mixer is dispensed into the beverage container 16. Thus, the user can enjoy a custom mixed cocktail without having to wait in line or interact with a bartender.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A cocktail dispensing assembly for mixing and dispensing a variety of cocktails, said assembly comprising:
a housing being positionable in an establishment licensed to sell alcohol wherein said housing is configured to be accessible to customers legally allowed to purchase alcohol, said housing having a dispensing outlet being integrated into said housing, said housing has a front wall and a back wall, said back wall having an opening extending through said back wall to access an interior of said housing, said dispensing outlet extending through said front wall wherein said dispensing outlet is configured to have a beverage container placed into said dispensing outlet;
an alcohol dispensing unit being integrated into said housing, said alcohol dispensing unit having a plurality of alcohol reservoirs each containing a respective distilled spirit, said alcohol dispensing unit including a plurality of alcohol buttons each being disposed on said housing, each of said alcohol buttons being in operational communication with a respective one of said alcohol reservoirs such each of said alcohol buttons actuates said respective reservoir to dispense a pre-determined volume of the distilled spirit outwardly through said dispensing outlet wherein said alcohol dispensing unit is configured to dispense the distilled spirit into the beverage container, each of said alcohol buttons being positioned on said front wall, said alcohol buttons being spaced apart from each other and being laterally distributed on said front wall;
a mixer dispensing unit being integrated into said housing, said mixer dispensing unit having a plurality of mixer reservoirs each containing a respective cocktail mixer, said mixer dispensing unit including a plurality of mixer buttons each being disposed on said housing, each of said mixer buttons being in operational communication with a respective one of said mixer reservoirs such each of said mixer buttons actuates said respective reservoir to dispense a pre-determined volume of the cocktail mixer outwardly through said dispensing outlet wherein said mixer dispensing unit is configured to dispense the cocktail mixer into the beverage container, each of said mixer buttons being positioned on said front wall of said housing, said mixer buttons being spaced apart from each other and being laterally distributed on said front wall, each of said mixer buttons being positioned beneath a respective one of said alcohol buttons;
a point of sale unit being integrated into said housing wherein said point of sale unit is configured to conduct a financial transaction to purchase a cocktail, said point of sale unit being in operational communication with each of said alcohol dispensing unit and said mixer dispensing unit;
an identification reader being integrated into said housing wherein said identification reader is configured to read a state issued identification card; and
a facial recognition unit being integrated into said housing wherein said facial recognition unit is configured to scan a face of a user, said facial recognition unit verifying the user's face with the information on the state issued identification card wherein said facial recognition unit is configured to inhibit an unauthorized user from purchasing alcohol.

2. The assembly according to claim 1, wherein:
said point of sale unit comprises a card reader being disposed on said front wall of said housing wherein said card reader is configured to have a credit card or debit card swiped through said card reader for purchasing the cocktail;
said identification reader is positioned on said front wall of said housing; and
said facial recognition unit is positioned on said front wall of said housing.

3. The assembly according to claim 1, further comprising:
a control circuit being integrated into said housing, said control circuit receiving a payment input and a verify input, said control circuit being normally de-actuated, said control circuit being actuated when said control circuit receives said payment input and said verify input; and
a dispensing valve being integrated into said housing, said dispensing valve having a pair of inlets and an outlet, said outlet being aligned with said dispensing outlet, said dispensing valve being electrically coupled to said control circuit.

4. The assembly according to claim 3, wherein:
each of said alcohol buttons is electrically coupled to said control circuit;
each of said alcohol reservoirs has an outlet port;
each of said alcohol reservoirs includes an alcohol valve being fluidly coupled to said outlet port, said alcohol valve associated with each of said alcohol reservoirs being electrically coupled to said control circuit, said alcohol valve associated with each of said alcohol reservoirs being assigned to a respective one of said alcohol buttons; and
said alcohol valve associated with a respective one of said alcohol reservoirs is actuated into an open condition when said respective alcohol button is depressed to facilitate the distilled spirit in said respective reservoir to flow through said alcohol valve, said alcohol valve associated with each of said alcohol reservoirs being fluidly coupled to a respective one of said inlets of said dispensing valve, said alcohol valve associated with each of said alcohol reservoirs being normally actuated into a closed condition, said alcohol valve associated with each of said alcohol reservoirs being actuatable into said open condition when said control circuit receives said payment input and said verify input.

5. The assembly according to claim 3, wherein:
each of said mixer buttons is electrically coupled to said control circuit;
each of said mixer reservoirs has an outlet port;
each of said mixer reservoirs includes a mixer valve being fluidly coupled to said outlet port of said mixer reservoirs, said mixer valve associated with each of said mixer reservoirs being electrically coupled to said control circuit, said mixer valve associated with each of said mixer reservoirs being assigned to a respective one of said mixer buttons; and
said mixer valve associated with a respective one of said mixer reservoirs is actuated into an open condition when said respective mixer button is depressed to facilitate the cocktail mixer in said respective reservoir to flow through said mixer valve, said mixer valve associated with each of said mixer reservoirs being fluidly coupled to a respective one of said inlets of said dispensing valve thereby facilitating said dispensing valve to mix the distilled spirit and the cocktail mixer together, said mixer valve associated with each of said mixer reservoirs being normally actuated into a closed condition, said mixer valve associated with each of said mixer reservoirs being actuatable into said open condition when said control circuit receives said payment input and said verify input.

6. The assembly according to claim 3, wherein said point of sale unit comprises a card reader being disposed on a front wall of said housing wherein said card reader is configured to have a credit card or debit card swiped through said card reader for purchasing the cocktail, said card reader being electrically coupled to said control circuit, said control circuit receiving said payment input when said card reader successfully charges the credit card or the debit card for the cost of the cocktail.

7. The assembly according to claim 3, wherein said facial recognition unit is electrically coupled to said control circuit, said control circuit receiving said verify input when said facial recognition unit verifies that the user's face matches the information on the state issued identification card, said facial recognition unit being positioned on said front wall of said housing.

8. The assembly according to claim 2, further comprising a door being hingedly disposed on said back wall of said housing, said door being aligned with said opening for opening and closing said opening, said door having a lock being integrated into said door, said lock engaging said back wall of said housing when said door is closed when said lock is in a locked condition, said lock being urgeable into an unlocked condition with a key for disengaging said back wall of said housing to facilitate said door to be opened.

9. A cocktail dispensing assembly for mixing and dispensing a variety of cocktails, said assembly comprising:
a housing being positionable in an establishment licensed to sell alcohol wherein said housing is configured to be accessible to customers legally allowed to purchase alcohol, said housing having a dispensing outlet being integrated into said housing, said housing having a front wall and a back wall, said back wall having an opening extending through said back wall to access an interior of said housing, said dispensing outlet extending through said front wall wherein said dispensing outlet is configured to have a beverage container placed into said dispensing outlet;
a control circuit being integrated into said housing, said control circuit receiving a payment input and a verify input, said control circuit being normally de-actuated, said control circuit being actuated when said control circuit receives said payment input and said verify input;
a dispensing valve being integrated into said housing, said dispensing valve having a pair of inlets and an outlet, said outlet being aligned with said dispensing outlet, said dispensing valve being electrically coupled to said control circuit;
an alcohol dispensing unit being integrated into said housing, said alcohol dispensing unit having a plurality of alcohol reservoirs each containing a respective distilled spirit, said alcohol dispensing unit including a plurality of alcohol buttons each being disposed on said housing, each of said alcohol buttons being in operational communication with a respective one of said alcohol reservoirs such each of said alcohol buttons actuates said respective reservoir to dispense a pre-determined volume of the distilled spirit outwardly through said dispensing outlet wherein said alcohol dispensing unit is configured to dispense the distilled spirit into the beverage container, each of said alcohol buttons being positioned on said front wall, said alcohol buttons being spaced apart from each other and being laterally distributed on said front wall, each of said alcohol buttons being electrically coupled to said control circuit, each of said alcohol reservoirs having an outlet port, each of said alcohol reservoirs including an alcohol valve being fluidly coupled to said outlet port, said alcohol valve associated with each of said alcohol reservoirs being electrically coupled to said control circuit, said alcohol valve associated with each of said alcohol reservoirs being assigned to a respective one of said alcohol buttons, said alcohol valve associated with a respective one of said alcohol reservoirs being actuated into an open condition when said respective alcohol button is depressed to facilitate the distilled spirit in said respective reservoir to flow through said alcohol valve, said alcohol valve associated with each of said alcohol reservoirs being fluidly coupled to a respective one of said inlets of said dispensing valve, said alcohol valve associated with each of said alcohol reservoirs being normally actuated into a closed condition, said alcohol valve associated with each of said alcohol reservoirs being actuatable into said open condition when said control circuit receives said payment input and said verify input;
a mixer dispensing unit being integrated into said housing, said mixer dispensing unit having a plurality of mixer reservoirs each containing a respective cocktail mixer, said mixer dispensing unit including a plurality of mixer buttons each being disposed on said housing, each of said mixer buttons being in operational communication with a respective one of said mixer reservoirs such each of said mixer buttons actuates said respective reservoir to dispense a pre-determined volume of the cocktail mixer outwardly through said dispensing outlet wherein said mixer dispensing unit is configured to dispense the cocktail mixer into the beverage container, each of said mixer buttons being positioned on said front wall of said housing, said mixer buttons being spaced apart from each other and being laterally distributed on said front wall, each of said mixer buttons being positioned beneath a respective one of said alcohol buttons, each of said mixer buttons being electrically coupled to said control circuit, each of said mixer reservoirs having an outlet port, each of said mixer reservoirs including a mixer valve being fluidly coupled to said outlet port of said mixer reservoirs, said mixer valve associated with each of said mixer reservoirs being electrically coupled to said control circuit, said mixer valve associated with each of said mixer reservoirs being assigned to a respective one of said mixer buttons, said mixer valve associated with a respective one of said mixer reservoirs being actuated into an open condition when said respective mixer button is depressed to facilitate the cocktail mixer in said respective reservoir to flow through said mixer valve, said mixer valve associated with each of said mixer reservoirs being fluidly coupled to a respective one of said inlets of said dispensing valve thereby facilitating said dispensing valve to mix the distilled spirit and the cocktail mixer together, said mixer valve associated with each of said mixer reservoirs being normally actuated into a closed condition, said mixer valve associated with each of said mixer reservoirs being actuatable into said open condition when said control circuit receives said payment input and said verify input;
a point of sale unit being integrated into said housing wherein said point of sale unit is configured to conduct a financial transaction to purchase a cocktail, said point of sale unit being in operational communication with each of said alcohol dispensing unit and said mixer dispensing unit, said point of sale unit comprising a card reader being disposed on said front wall of said housing wherein said card reader is configured to have a credit card or debit card swiped through said card reader for purchasing the cocktail, said card reader being electrically coupled to said control circuit, said control circuit receiving said payment input when said card reader successfully charges the credit card or the debit card for the cost of the cocktail;
an identification reader being integrated into said housing wherein said identification reader is configured to read a state issued identification card, said identification reader being positioned on said front wall of said housing, said identification reader being electrically coupled to said control circuit;
a facial recognition unit being integrated into said housing wherein said facial recognition unit is configured to scan a face of a user, said facial recognition unit verifying the user's face with the information on the state issued identification card wherein said facial recognition unit is configured to inhibit an unauthorized user from purchasing alcohol, said facial recognition unit being electrically coupled to said control circuit, said control circuit receiving said verify input when said facial recognition unit verifies that the user's face matches the information on the state issued identification card, said facial recognition unit being positioned on said front wall of said housing;
a door being hingedly disposed on said back wall of said housing, said door being aligned with said opening for opening and closing said opening, said door having a lock being integrated into said door, said lock engaging said back wall of said housing when said door is closed when said lock is in a locked condition, said lock being urgeable into an unlocked condition with a key for disengaging said back wall of said housing to facilitate said door to be opened; and
a power cord being coupled to and extending away from said housing, said power cord being electrically coupled to said control circuit, said power cord having a distal end with respect to said housing, said distal end having a male plug being electrically coupled to said distal end wherein said male plug is configured to be plugged into a power source comprising a female electrical outlet.
